(19) United States
(12) Patent Application Publication
(10) Pub. No.: US 2026/0120641 A1
(43) Pub. Date: Apr. 30, 2026

(54) DISPLAY PANEL AND DISPLAY DEVICE

(71) Applicant: HKC CORPORATION LIMITED, Shenzhen (CN)

(72) Inventors: Xiufeng ZHOU, Shenzhen (CN); Xin YUAN, Shenzhen (CN); Chen CHEN, Shenzhen (CN); Haijiang YUAN, Shenzhen (CN)

(73) Assignee: HKC CORPORATION LIMITED, Shenzhen (CN)

(21) Appl. No.: 19/368,472

(22) Filed: Oct. 24, 2025

(30) Foreign Application Priority Data
Oct. 31, 2024 (CN) 202411548944.2

(51) Int. Cl. G09G 3/3233

(52) U.S. Cl. CPC G09G 3/3233; G09G 2300/043; G09G 2300/0819; G09G 2300/0852; G09G 2310/08

(57) ABSTRACT

Provided is a display panel and a display device. The display panel includes data lines, scan lines, and pixel units. The pixel unit is configured to receive a scan signal from the scan line and a data signal from the data line, and to perform image display based on the data signal. The pixel unit includes a driving module, an adjustment module, a light-emitting module, an initialization module, and a preset node. The driving module is electrically connected to the adjustment module, the light-emitting module, the initialization module, and the preset node. The preset node is also electrically connected to the adjustment module and the initialization module. The initialization module is configured to initialize the preset node to control the preset node to be at an initial potential. The adjustment module is configured to receive a power supply voltage to charge the preset node to a preset potential.

### CROSS REFERENCE TO RELATED APPLICATION

This application claims priority to Chinese Patent Application No. 202411548944.2, filed October 31, 2024, the entire disclosure of which is incorporated herein by reference.

### TECHNICAL FIELD

This application relates to the field of display technology, particularly to a display panel and a display device.

### BACKGROUND

Organic light-emitting diode (OLED) display devices have many advantages such as self-luminous, low driving current, high luminous efficiency, short response time, high clarity and contrast, nearly 180° viewing angle, wide operating temperature range, and the ability to achieve flexible display and large-area full-color display. They are considered to be the most promising display devices in the industry. However, since the OLED’s light-emitting material is driven by current, when the panel size becomes larger, in order to reduce the heat generation of the OLED large-size panel, the current for driving the OLED light-emitting material needs to be as small as possible. At this time, the transistor controlling the driving current is prone to threshold voltage changes, resulting in different driving currents flowing through the transistor when controlled by the same data voltage, thereby causing different OLED light-emitting intensities and resulting in poor display effects on the display panel.

Therefore, how to adjust and compensate for the threshold voltage change of the driving switch transistor to improve the display effect is an urgent problem to be solved.

### SUMMARY

Embodiments of the disclosure provide a display panel, which includes multiple data lines, multiple scan lines, and multiple pixel units arranged in an array. The pixel units are configured to receive scan signals from the scan lines and data signals from the data lines under the control of the scan signals, and to perform image display based on the data signals. The pixel unit includes a driving module, an adjustment module, a light-emitting module, an initialization module, and a preset node. The driving module is electrically connected to the adjustment module, the light-emitting module, the initialization module, and the preset node. The preset node is also electrically connected to the adjustment module and the initialization module. The initialization module is used to initialize the preset node to control the preset node to be at an initial potential. The adjustment module is configured to receive a power supply voltage to charge the preset node to a preset potential, thereby adjusting a threshold voltage of a driving switch transistor in the driving module to a preset value. The driving module is used to drive the light-emitting module to emit light based on the data signals.

Embodiments of the disclosure provide a display device, which includes a power supply module and the display panel as described above. The power supply module is configured to provide a driving power supply for the display panel to drive the display panel to perform image display.

### BRIEF DESCRIPTION OF THE DRAWINGS

To more clearly illustrate the technical solutions of the embodiments of the disclosure, the accompanying drawings used in the embodiments will be briefly introduced below. It should be apparent that the drawings described below are some embodiments of the disclosure. For those of ordinary skill in the art, other drawings can also be obtained based on these drawings without creative work.

FIG. 1 is a structural diagram of a display device according to an embodiment of the disclosure.

FIG. 2 is a plan layout diagram of the display panel in FIG. 1.

FIG. 3 is an equivalent circuit diagram of the pixel unit in FIG. 2.

FIG. 4 is a signal output timing diagram of FIG. 3.

FIG. 5 is a conduction curve change diagram of the first switch transistor in FIG. 3.

FIG. 6 is a signal output timing diagram of the first compensation mode.

FIG. 7 is a signal output timing diagram of the second compensation mode.

display device − 100, display panel − 10, power supply module − 20, m data lines − S1~Sm, n scan lines − G1~Gn, first direction − F1, second direction − F2, timing control circuit − 11, data driving circuit − 12, scan driving circuit − 13, pixel unit − 15, driving module − 151, adjustment module − 152, light-emitting module − 153, initialization module − 154, first signal receiving module − 155, second signal receiving module − 156, first storage module − 157, second storage module − 158, light-emitting control module − 159, first node − N1, second node − N2, third node − N3, fourth node − N4, driving switch transistor − DT, first switch transistor - T1, second switch transistor − T2, third switch transistor − T3, fourth switch transistor − T4, fifth switch transistor − T5, first capacitor − C1, second capacitor − C2, light-emitting element − E, scan line − G, data line − S, light-emitting control end − EM, first adjustment end − K1, second adjustment end − K2, reference voltage end − ER, driving voltage end − VDD, low voltage end − VSS, voltage at the driving voltage end-V_{DD}, voltage at the low voltage end − V_{SS}, first period − t1, second period − t2, third period − t3, fourth period − t4, data signal − Data, V_{TG_S} − voltage difference between a first control end and a first conductive end of the driving switch transistor, V_{MG_S} − voltage difference between a second control end and a first conductive end of the driving switch transistor, I_{DS} - current in the driving switch transistor

### DETAILED DESCRIPTION

To facilitate the understanding of the disclosure, the following will describe the disclosure in more detail with reference to the accompanying drawings. The drawings show the preferred embodiments of the disclosure. However, the disclosure can be implemented in many different forms and is not limited to the embodiments described in this article. On the contrary, the purpose of providing these embodiments is to make the content of the disclosure more thoroughly understood.

The following description of each embodiment is with reference to the accompanying drawings, which are used to illustrate specific embodiments of the disclosure. The numbers assigned to the components in the text, such as “first,” “second,” etc., are merely used to distinguish the described objects and do not have any order or technical meaning. The terms “connected” and “coupled” used in the disclosure include both direct and indirect connections (couplings) unless otherwise specifically stated. The directional terms used in the disclosure, such as “up,” “down,” “front,” “back,” “left,” “right,” “inside,” “outside,” “sideways,” etc., are merely refer to the directions in the accompanying drawings. Therefore, the directional terms used are intended to better and more clearly describe and understand the disclosure and should not be construed as limiting the disclosure.

In the description of the disclosure, it should be noted that unless otherwise clearly defined and limited, the terms “mounted,” “connected,” and “coupled” should be broadly understood. For example, they can be fixed connections, detachable connections, or integrated connections; they can be mechanical connections; they can be direct connections or indirect connections through intermediate media, and can be internal connections between two elements. For ordinary technicians in this field, the specific meanings of the above terms in the disclosure can be understood in specific situations. It should be noted that the terms “first,” “second,” etc. used in the description of the disclosure are used to distinguish different objects and are not used to describe specific orders.

In addition, the terms “comprising,” “including,” “containing,” or “having” used in the disclosure indicate the existence of the corresponding functions, operations, elements, etc., as disclosed, and do not limit the presence of one or more additional functions, operations, elements, etc. Moreover, the terms “comprising” or “containing” indicate the existence of the corresponding features, numbers, steps, operations, elements, components, or combinations thereof as disclosed in the description, but do not exclude the presence or addition of one or more other features, numbers, steps, operations, elements, components, or combinations thereof, and are intended to cover non-exclusive inclusions. Furthermore, when describing the embodiments of the disclosure, the term “may” is used to indicate “one or more embodiments of the disclosure.” Additionally, the term “exemplary” is intended to refer to an example or illustration. The term “phase” and “period” can be used interchangeably, for example, the term non-display phase can be replaced with non-display period, and the term vertical blanking phase can be replaced with vertical blanking period

Unless otherwise defined, all technical and scientific terms used in the disclosure have the same meanings as commonly understood by those skilled in the art to which the disclosure belongs. The terms used in the description of the disclosure are intended to describe specific embodiments and are not intended to limit the disclosure.

In view of the deficiencies of the above-mentioned technical problems, this application provides a display panel and a display device that can effectively adjust a threshold voltage of a driving switch transistor.

This disclosure discloses a display panel, which includes multiple data lines, multiple scan lines, and multiple pixel units arranged in an array. The pixel units are configured to receive scan signals from the scan lines and data signals from the data lines under the control of the scan signals, and to perform image display based on the data signals. The pixel unit includes a driving module, an adjustment module, a light-emitting module, an initialization module, and a preset node. The driving module is electrically connected to the adjustment module, the light-emitting module, the initialization module, and the preset node. The preset node is also electrically connected to the adjustment module and the initialization module. The initialization module is used to initialize the preset node to control the preset node to be at an initial potential. The adjustment module is configured to receive a power supply voltage to charge the preset node to a preset potential, thereby adjusting a threshold voltage of a driving switch transistor in the driving module to a preset value. The driving module is used to drive the light-emitting module to emit light based on the data signals.

Optionally, the pixel unit further includes a first node, a second node, and a third node, the third node is the preset node. The driving module includes a driving switch transistor, where a first control end of the driving switch transistor is electrically connected to the first node, a second control end of the driving switch transistor is electrically connected to the third node, a first conductive end of the driving switch transistor is electrically connected to a power supply voltage end, and a second conductive end of the driving switch transistor is electrically connected to the second node. When the third node is at the initial potential, the driving switch transistor is turned on, and the power supply voltage end is configured to charge the third node to the preset potential through the driving switch transistor and the adjustment module, thereby controlling the driving switch transistor to be turned off and adjusting the threshold voltage of the driving switch transistor to the preset value.

Optionally, the pixel unit further include a first signal receiving module and a second signal receiving module. The first signal receiving module is electrically connected to the first node and the data line, and the second signal receiving module is electrically connected to a reference voltage end and the second node. The first signal receiving module is configured to receive an adjustment signal or the data signal from the data line and transmit the adjustment signal or the data signal to the first node. The adjustment signal is used to cooperate with the adjustment module to adjust the threshold voltage of the driving switch transistor. The data signal is used to control the driving module to drive the light-emitting module to emit light. The second signal receiving module is configured to receive a reference signal from the reference voltage end to control the second node to be at the initial potential.

Optionally, the pixel unit further includes a first storage module and a second storage module. The first storage module is electrically connected between the first node and the power supply voltage end, and the second storage module is electrically connected between the third node and the power supply voltage end. The first storage module is configured to store and maintain the voltage of the first node, and the second storage module is configured to store and maintain the voltage of the third node.

Optionally, the pixel unit further include a light-emitting control module and a fourth node. The light-emitting control module is electrically connected to the second node and the fourth node and is electrically connected to the light-emitting module through the fourth node where the light-emitting control module is configured to control the second node to be electrically connected to the fourth node.

Optionally, the adjustment module includes a first switch transistor, and the initialization module includes a second switch transistor. A control end of the first switch transistor is electrically connected to a first adjustment end, a first conductive end of the first switch transistor is electrically connected to the second node, and a second conductive end of the first switch transistor is electrically connected to the third node. The first switch transistor is configured to be turned on under the control of the first adjustment end to control the second node to be electrically connected to the third node. A control end of the second switch transistor is electrically connected to a second adjustment end, a first conductive end of the second switch transistor is electrically connected to a reference voltage end, and a second conductive end of the second switch transistor is electrically connected to the third node. The second switch transistor is configured to be turned on under the control of the second adjustment end to receive the reference signal from the reference voltage end and transmit the reference signal to the third node, thereby controlling the third node to be at the initial potential.

Optionally, the first signal receiving module includes a third switch transistor, and the second signal receiving module includes a fourth switch transistor. A control end of the third switch transistor is electrically connected to the scan line, a first conductive end of the third switch transistor is electrically connected to the data line, and a second conductive end of the third switch transistor is electrically connected to the first node. A control end of the fourth switch transistor is electrically connected to the second adjustment end, a first conductive end of the fourth switch transistor is electrically connected to the reference voltage end, and a second conductive end of the fourth switch transistor is electrically connected to the second node. The third switch transistor is configured to be turned on under the control of the scan signal to receive the data signal or the adjustment signal from the data line and transmit the data signal and the adjustment signal to the first node. The fourth switch transistor is configured to be turned on under the control of the second adjustment end to receive the reference signal from the reference voltage end and transmit the reference signal to the second node, thereby controlling the second node to be at the initial potential.

Optionally, the first storage module includes a first capacitor, the second storage module includes a second capacitor, and the light-emitting control module includes a fifth switch transistor. The first capacitor is electrically connected between the first node and the power supply voltage end, and the second capacitor is electrically connected between the third node and the power supply voltage end. The first capacitor is configured to maintain a voltage difference between the first node and the power supply voltage end, and the second capacitor is configured to maintain a voltage difference between the third node and the power supply voltage end. A control end of the fifth switch transistor is electrically connected to a light-emitting control end, a first conductive end of the fifth switch transistor is electrically connected to the second node, and a second conductive end of the fifth switch transistor is electrically connected to the fourth node. The fifth switch transistor is configured to be turned on under the control of the light-emitting control end to control the second node to be electrically connected to the fourth node.

Optionally, in a first period which is an initialization phase, the second switch transistor, the third switch transistor, the fourth switch transistor, and the fifth switch transistor are turned on, while the first switch transistor is turned off. The data line is configured to transmit an adjustment signal to the first node through the third switch transistor. The reference voltage end is configured to transmit a reference signal to the second node and the third node through the fourth switch transistor and the second switch transistor, and further transmit the reference signal to the fourth node through the fifth switch transistor, thereby initializing the second node, the third node, and the fourth node. In a second period which is a compensation phase, the second switch transistor, the fourth switch transistor, and the fifth switch transistor are turned off, and the driving switch transistor and the first switch transistor are turned on. The power supply voltage end is configured to charge the third node through the driving switch transistor and the first switch transistor. When the third node reaches the preset potential, the driving switch transistor is turned off, thereby adjusting the threshold voltage of the driving switch transistor to the preset value. The second capacitor is configured to maintain the voltage of the third node. In a third period which is a data writing phase, the third switch transistor is turned on, and the first switch transistor, the second switch transistor, the fourth switch transistor, and the fifth switch transistor are turned off. The data signal is transmitted to the first node through the third switch transistor, and the first capacitor is configured to maintain the voltage of the first node. In a fourth period which is a light-emitting phase, the first switch transistor, the second switch transistor, the third switch transistor, and the fourth switch transistor are turned off, and the driving switch transistor and the fifth switch transistor are turned on. The power supply voltage end is configured to drive the light-emitting module to emit light through the driving switch transistor and the fifth switch transistor.

Optionally, the first period and the second period are executed in a non-image display phase, and the third period and the fourth period are executed in an image display phase, where the non-display phase is a non-display phase during startup.

Optionally, the first period and the second period are executed in a non-image display phase, and the third period and the fourth period are executed in an image display phase, where the non-image display phase is a vertical blanking phase; the vertical blanking phase is between two adjacent frames of the image display phase. The display panel is configured to execute the first period and the second period in each frame’s vertical blanking phase, or the display panel is configured to execute the first period and the second period once in every a frames’ vertical blanking phase, where a is an integer greater than 1.

Optionally, in each frame of the image display phase, the pixel unit is configured to sequentially execute the first period, the second period, the third period, and the fourth period.

This disclosure also provides a display device, which includes a power supply module and the display panel as described above. The power supply module is configured to provide a driving power supply for the display panel to drive the display panel to perform image display.

Compared with the existing technical problems, in this disclosure, the adjustment module is provided to adjust the threshold voltage of the driving module to a preset range, eliminating the light-emitting intensity difference caused by different threshold voltages of the driving module between adjacent pixel units, thereby avoiding the brightness difference between adjacent pixel units and effectively improving the display effect.

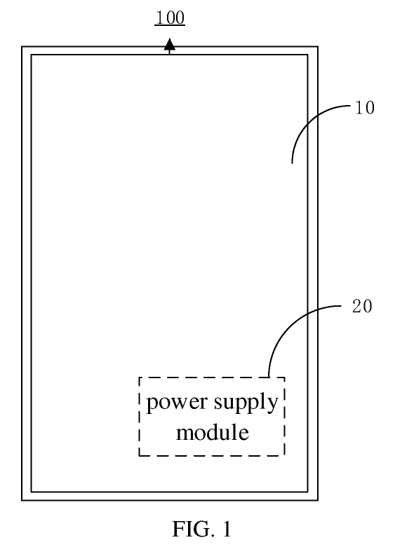

Please refer to FIG. 1, which is a structural diagram of a display device 100 according to a first embodiment of the disclosure. The display device 100 includes a display panel 10 and a power supply module 20. The power supply module 20 is located on the backside of the display panel 10, that is, a non-display side of the display panel 10. The power supply module 20 is configured to provide a driving current for the display panel 10 to perform image display.

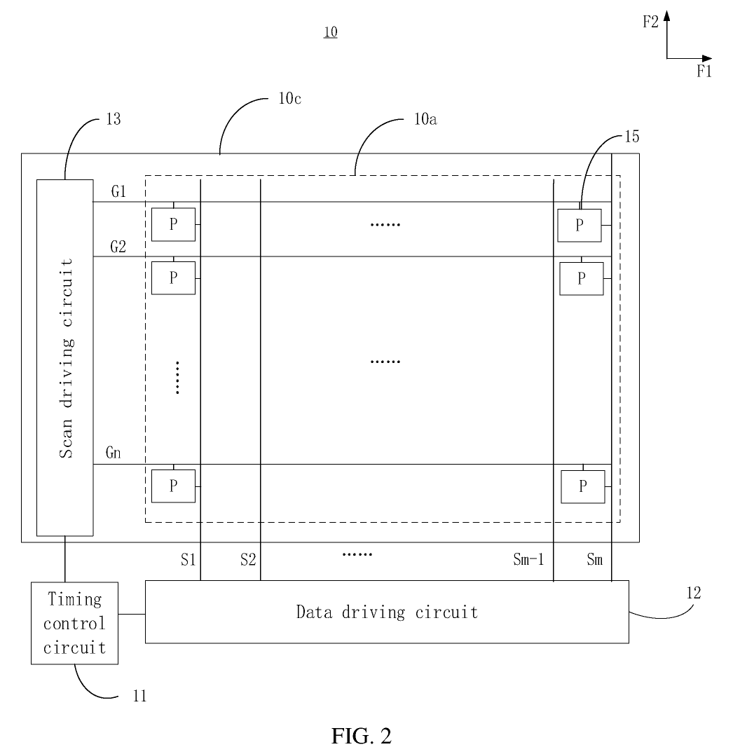

Please refer to FIG. 2, which is a plan layout diagram of the display panel in FIG. 1.

As illustrated in FIG. 2, the display panel 10 includes multiple pixel units 15 arranged in a matrix in a display area 10a of the array substrate 10c, m data lines S1~Sm, and n scan lines G1~Gn, where m and n are natural numbers greater than 1. Additionally, there are a timing control circuit 11, a data driving circuit 12, and a scan driving circuit 13 located in the non-display area of the array substrate 10c. The n scan lines G1~Gn extend along a first direction F1 and are insulated and parallel to each other along a second direction F2. The m data lines S1~Sm extend along the second direction F2 and are insulated and parallel to each other along the first direction F1, with the first direction F1 being perpendicular to the second direction F2.

The timing control circuit 11 is electrically connected to the data driving circuit 12 and the scan driving circuit 13 to control the operating timing of the data driving circuit 12 and the scan driving circuit 13. That is, the timing control circuit 11 is configured to output corresponding timing control signals to the data driving circuit 12 and the scan driving circuit 13 to control the data driving circuit 12 to output a data signal(s) and the scan driving circuit 13 to output a scan signal(s). The pixel units 15 are configured to receive, based on the scan signals, the data signals for image display, to perform image display.

The data driving circuit 12 is electrically connected to the m data lines S1~Sm and is configured to transmit the data signal (Data) for display to the multiple pixel units 15 in the form of data voltage through the m data lines S1~Sm.

The scan driving circuit 13 is electrically connected to the n scan lines G1~Gn and is configured to output a scan signal(s) through the n scan lines G1~Gn to control when the pixel units 15 receives the data signal(s). In some embodiments, the scan driving circuit 13 can output scan signals in sequence from scan line G1, G2, ..., to Gn according to a scanning period, according to the arrangement order of the n scan lines G1~Gn, thereby controlling the pixel units 15 to receive data signals for image display. Of course, the scan signals can also be output according to other timings as needed, and the disclosure does not limit this.

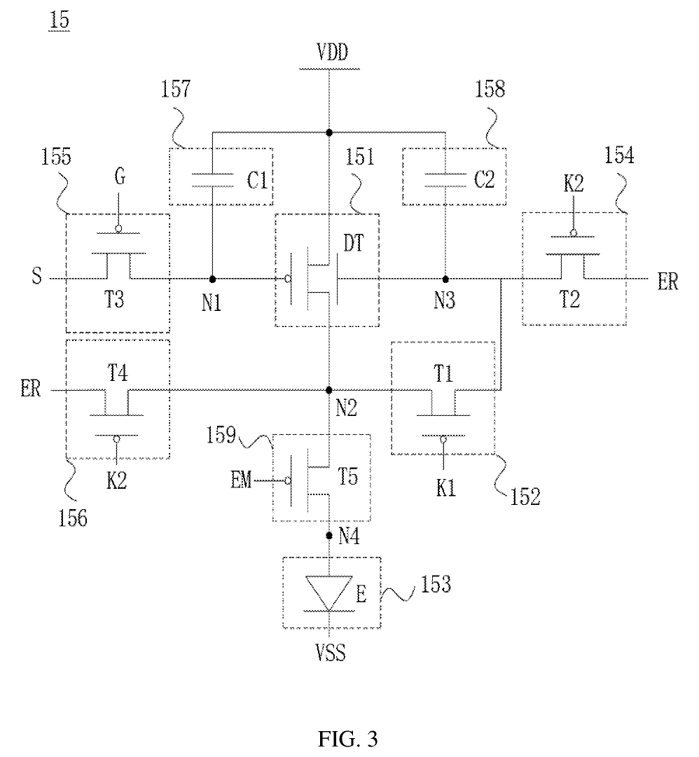

Please refer to FIG. 3, which is an equivalent circuit diagram of the pixel unit in FIG. 2.

As illustrated in FIG. 3, the pixel unit 15 includes a driving module 151, an adjustment module 152, a light-emitting module 153, an initialization module 154, and a preset node. The driving module 151 is electrically connected to the adjustment module 152, the light-emitting module 153, the initialization module 154, and the preset node. The preset node is also electrically connected to the adjustment module 152 and the initialization module 154. The initialization module 154 is configured to initialize the preset node to control the preset node at an initial potential. The adjustment module 152 is configured to control the driving module151 to receive a power supply voltage to charge the preset node to a preset potential, thereby adjusting a threshold voltage of the driving switch transistor DT in the driving module 151 to a preset value. The driving module 151 is configured to drive during the image display phase, based on the data signals, the light-emitting module 153 to emit light.

By forming a conductive path with the power supply voltage end VDD, the driving module 151, and the adjustment module 152, the threshold voltage of the driving switch transistor in the driving module 151 can be adjusted to a preset range during charging of the preset node by the power supply voltage end VDD. This effectively eliminates the difference in light-emitting intensities caused by different threshold voltages of the driving module 151 between adjacent pixel units, thereby avoiding brightness differences between adjacent pixel units 15 and improving the display effect.

In this embodiment, the pixel unit 15 further includes a first node N1, a second node N2, and a third node N3, where the third node N3 is the preset node. The driving module 151 includes a driving switch transistor DT, where a first control end of the driving switch transistor DT is electrically connected to the first node N1 and further electrically connected to the first signal receiving module 155 through the first node N1. A second control end of the driving switch transistor DT is electrically connected to the third node N3 and further electrically connected to the initialization module 154 through the third node N3. A first conductive end of the driving switch transistor DT is electrically connected to the power supply voltage end VDD, and a second conductive end of the driving switch transistor DT is electrically connected to the second node N2. That is, the driving switch transistor DT is a dual-gate transistor with the first control end and the second control end. The driving switch transistor DT is configured to be conductive under the control of the first control end and/or the second control end. The adjustment module 152 is electrically connected to the second node N2 and the third node N3. When the second node N2 and the third node N3 are electrically connected through the adjustment module 152, the power supply voltage end VDD, the driving switch transistor DT, the second node N2, the adjustment module 152, and the third node N3 form a conductive path. The power supply voltage end VDD can charge the second node N2 through the driving switch transistor DT and the adjustment module 152. When the second node N2 is charged to a preset voltage, the driving switch transistor DT is turned off, and at this time, the threshold voltage of the driving switch transistor DT is adjusted to the preset value.

The pixel unit 15 further includes a first signal receiving module 155 and a second signal receiving module 156, where the first signal receiving module 155 is electrically connected to the data line S and the first node N1. During the initialization phase and the compensation phase, the first signal receiving module 155 is configured to receive an adjustment signal from the data line S and transmit the adjustment signal to the first node N1 to cooperate with the adjustment module 152 to adjust the threshold voltage of the driving switch transistor DT. During the data writing phase, the first signal receiving module 155 is configured to receive the data signal from the data line S and transmit the data signal to the first node N1. The driving module 151 is configured to control the light-emitting module 153 to emit light based on the data signal.

The second signal receiving module 156 is electrically connected to a reference voltage end ER and the second node N2 and is configured to receive a reference signal from the reference voltage end ER and transmit the reference signal to the second node N2. The reference signal is used to initialize the second node N2 to adjust the second node N2 to an initial potential.

The pixel unit 15 further includes a first storage module 157 and a second storage module 158, where the first storage module 157 is electrically connected between the first node N1 and the power supply voltage end VDD, and the second storage module 158 is electrically connected between the third node N3 and the power supply voltage end VDD. The first storage module 157 is configured to store and maintain the voltage of the first node N1, and the second storage module 158 is configured to store and maintain the voltage of the third node N3.

The pixel unit 15 further includes a light-emitting control module 159, which is electrically connected to the second node N2 and the fourth node N4 and further electrically connected to the light-emitting module 153 through the fourth node N4. During the initialization phase, the light-emitting control module 159 controls the reference signal of the second node N2 to be transmitted to the fourth node N4. During the light-emitting phase, the light-emitting control module 159 is configured to receive the power supply voltage from the driving switch transistor DT and transmit the power supply voltage to the light-emitting module 153 to drive the light-emitting module 153 to emit light.

Specifically, the adjustment module 152 includes a first switch transistor T1, where a control end of the first switch transistor T1 is electrically connected to a first adjustment end K1. A first conductive end of the first switch transistor T1 is electrically connected to the second node N2, and a second conductive end of the first switch transistor T1 is electrically connected to the third node N3 and further electrically connected to the second control end of the driving switch transistor DT through the third node N3. The first switch transistor T1 is configured to be turned on under the control of the first adjustment end K1 to control the second node N2 to be electrically connected to the third node N3. That is, during the compensation phase, the first switch transistor T1 is configured to receive the power supply voltage from the second node N2 and transmit the power supply voltage to the third node N3, to charge the third node N3 to a preset potential to control the driving switch transistor DT to be turned off.

The light-emitting module 153 includes a light-emitting element E, which can be an organic light-emitting diode. The anode of the light-emitting element E is electrically connected to the second node N2, and the cathode of the light-emitting element E is electrically connected to the low voltage end VSS. The light-emitting module 153 is configured to emit light based on the driving current transmitted by the driving switch transistor DT to perform image display.

The initialization module 154 includes a second switch transistor T2, where a control end of the second switch transistor T2 is electrically connected to a second adjustment end K2. A first conductive end of the second switch transistor T2 is electrically connected to the reference voltage end ER, and a second conductive end of the second switch transistor T2 is electrically connected to the third node N3. The second switch transistor T2 is configured to be turned on under the control of the second adjustment end K2 to receive the reference signal from the reference voltage end ER and transmit the reference signal to the third node N3 to initialize the third node N3 to control the third node N3 at an initial potential.

The first signal receiving module 155 includes a third switch transistor T3, and the second signal receiving module 156 includes a fourth switch transistor T4. A control end of the third switch transistor T3 is electrically connected to the scan line G. A first conductive end of the third switch transistor T3 is electrically connected to the data line S, and a second conductive end of the third switch transistor T3 is electrically connected to the first node N1. The third switch transistor T3 is configured to be turned on under the control of the scan signal to receive the adjustment signal or data signal from the data line and transmit the adjustment signal or data signal to the first node N1.

A control end of the fourth switch transistor T4 is electrically connected to the second adjustment end K2. A first conductive end of the fourth switch transistor T4 is electrically connected to the reference voltage end ER, and a second conductive end of the fourth switch transistor T4 is electrically connected to the second node N2. The fourth switch transistor T4 is configured to be turned on under the control of the second adjustment end K2 to receive the reference signal from the reference voltage end ER and transmit the reference signal to the second node N2.

The first storage module 157 includes a first capacitor C1, and the second storage module 158 includes a second capacitor C2. A first end of the first capacitor C1 is electrically connected to the first node N1, and a second end of the first capacitor C1 is electrically connected to the power supply voltage end VDD. That is, the first capacitor C1 is electrically connected between the first control end and the first conductive end of the driving switch transistor DT. The first capacitor C1 is configured to store the charge at the first node N1 to maintain the voltage of the first node N1.

A first end of the second capacitor C2 is electrically connected to the third node N3, and a second end of the second capacitor C2 is electrically connected to the power supply voltage end VDD. That is, the second capacitor C2 is electrically connected between the second control end and the first conductive end of the driving switch transistor DT. The second capacitor C2 is configured to store the charge at the third node N3 to maintain the voltage of the third node N3.

The light-emitting control module 159 includes a fifth switch transistor T5, where a control end of the fifth switch transistor T5 is electrically connected to the light-emitting control end EM. A first conductive end of the fifth switch transistor T5 is electrically connected to the second node N2, and a second conductive end of the fifth switch transistor T5 is electrically connected to the fourth node N4. The fifth switch transistor T5 is configured to be turned on under the control of the light-emitting control end EM to receive the driving current from the second node N2 and transmit the driving current to the source of the light-emitting element E to drive the light-emitting element E to emit light.

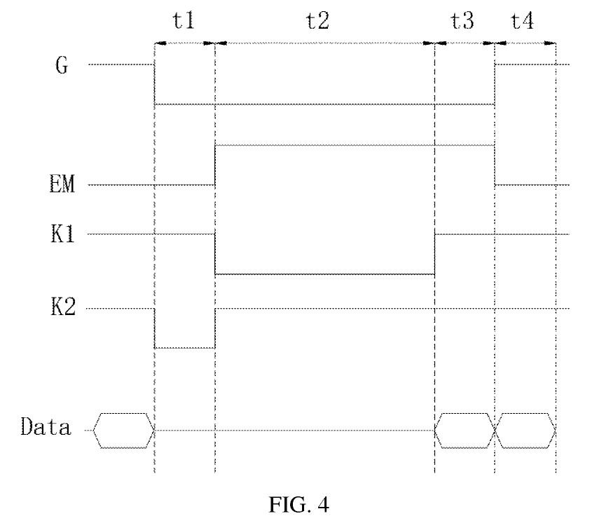

Please refer to FIG. 4, which is a signal output timing diagram of FIG. 3.

As illustrated in FIG. 4, during the first period t1, which is the initialization phase, the second switch transistor T2, the third switch transistor T3, the fourth switch transistor T4, and the fifth switch transistor T5 are turned on, while the first switch transistor T1 is turned off. The data line S is configured to transmit an adjustment signal to the first node N1 through the third switch transistor T3. The first capacitor C1 is configured to maintain the potential of the first node N1. The reference voltage end ER is configured to transmit a reference signal to the third node N3 and the second node N2 through the second switch transistor T2 and the fourth switch transistor T4, respectively, and further transmits the reference signal to the fourth node N4 through the fifth switch transistor T5. This initializes the second node N2, the third node N3, and the fourth node N4. The second capacitor C2 is configured to maintain the voltage of the third node N3, and V_{ER} < V_{SS} + Vₑₗ, where Vₑₗ is the turn-on voltage of the light-emitting element E. That is, the reference signal transmitted to the second node N2 and the third node N3 is insufficient to drive the light-emitting element E to emit light. By transmitting the power supply voltage to the first node N1, the voltage difference across the first capacitor C1 is zero, that is, the voltage difference between the first control end and the first conductive end of the driving switch transistor DT is controlled to be zero.

During the second period t2, which is the compensation phase, the second switch transistor T2, the fourth switch transistor T4, and the fifth switch transistor T5 are turned off, while the first switch transistor T1 and the third switch transistor T3 are turned on. The driving switch transistor DT is configured to be turned on under the control of the first node N1 and the third node N3. The power supply voltage end VDD, the driving switch transistor DT, the first switch transistor T1, and the third node N3 form a charging path to charge the third node N3. When the third node N3 reaches the preset potential, the driving switch transistor DT is turned off, and at this time, the threshold voltage of the driving switch transistor DT is adjusted to the preset value.

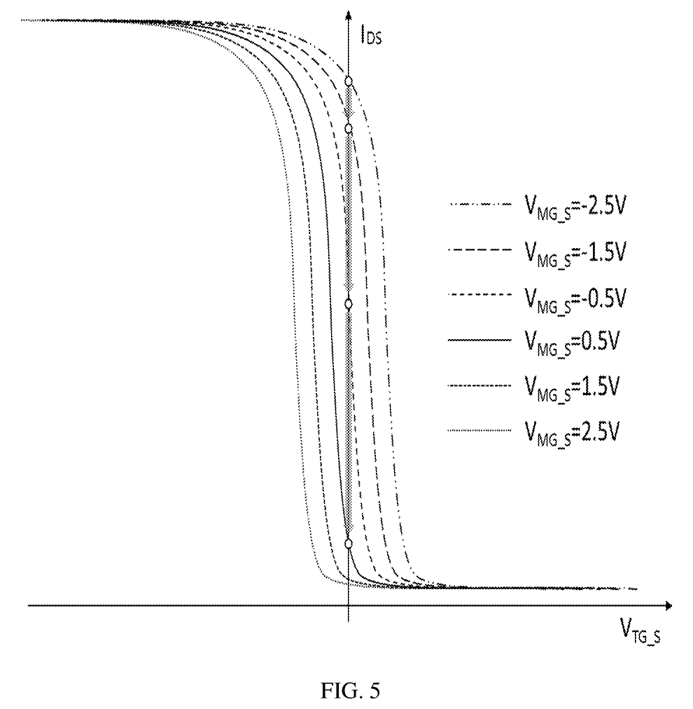

As illustrated in FIG. 5, which is a conduction curve change diagram of the driving switch transistor in FIG. 3. TG represents the first control end of the driving switch transistor DT, and MG represents the second control end of the driving switch transistor DT. V_{TG_S} is the voltage difference between the first control end and the first conductive end of the driving switch transistor DT, that is, the voltage difference between the first gate and the source. V_{MG_S} is the voltage difference between the second control end and the first conductive end of the driving switch transistor DT, that is, the voltage difference between the second gate and the source. I_{DS} is the magnitude of the current flowing through the driving switch transistor DT.

The following will provide a detailed description of the charging process based on the curve with V_{MG_S} = −2.5V. At the beginning of the second period t2, for example, with V_{MG_S} = −2.5V (V_{N3} − V_{DD} = −2.5V) and V_{TG_S} = 0V (V_{N1} − V_{DD} = 0V), I_{DS} > 0, and the driving switch transistor DT is in a conductive state. As the second period t2 progresses, the power supply voltage end VDD charges the third node N3 through the driving switch transistor DT and the first switch transistor T1, causing the voltage of the third node N3 to gradually increase. Since the voltage of the power supply voltage end VDD is greater than that of the third node N3, the voltage difference (V_{MG_S}) between the third node N3 and the power supply voltage end VDD gradually decreases. After the voltage of the third node N3 exceeds that of the power supply voltage end VDD, the voltage difference(V_{MG_S}) between the third node N3 and the power supply voltage end VDD gradually increases. That is, the change of V_{MG_S} is first decreasing and then increasing. This means that during the entire charging process, as indicated by the arrow on the vertical coordinate axis, while V_{TG_S} remains unchanged and V_{MG_S} first decreases and then increases, I_{DS} gradually decreases. When the voltage of the third node N3 rises to the preset voltage V_{MG}, I_{DS} becomes negligible, and at this time, the driving switch transistor DT is considered to be turned off. The threshold voltage Vₜₕ is the critical voltage for the transition between conduction and cutoff of the driving switch transistor DT, that is, when the voltage of the third node N3 or the second control end of the driving switch transistor DT rises to the preset voltage V_{MG}, the voltage difference between the first control end and the source (V_{TG_S}) of the driving switch transistor DT equals the threshold voltage Vₜₕ of the driving switch transistor DT. In this embodiment, Vₜₕ = V_{TG_S} = 0. In other embodiments, in the first period t1, V_{TG_S} (V_{N1} − V_{DD}) can be set to other values. Since V_{TG_S} remains unchanged during the second period t2, the threshold voltage Vₜₕ can also be other values. That is, the threshold voltage Vₜₕ can be set according to specific needs, and the disclosure does not limit this.

During the third period t3, which is the data writing phase, the third switch transistor T3 is turned on, while the first switch transistor T1, the second switch transistor T2, the fourth switch transistor T4, and the fifth switch transistor T5 are turned off. The second capacitor C2 is configured to store charge and maintain the voltage of the third node N3. The data line S is configured to output data voltage V_{Data} (data signal) to the first node N1 through the third switch transistor T3. The first capacitor C1 is configured to maintain the voltage of the first node N1. At this time, the voltage difference between the first control end of the driving switch transistor DT and the power supply voltage end VDD is the difference between the data voltage and the power supply voltage, that is, V_{TG_S} = V_{N1} − V_{DD} = V_{Data} − V_{DD}.

During the fourth period t4, the first switch transistor T1, the second switch transistor T2, the third switch transistor T3, and the fourth switch transistor T4 are turned off, while the fifth switch transistor T5 and the driving switch transistor DT are turned on. The power supply voltage end VDD and the low voltage end VSS form a path, with the driving switch transistor DT and the light-emitting element E dividing the voltage. The voltage of the fourth node N4 rises to V_{E} + V_{SS} to drive the light-emitting element E to emit light, where V_{E} is the voltage used to drive the light-emitting element E to emit light. As the voltage of the fourth node N4 rises, the current through the light-emitting element E is I = (k/2)(V_{TG_S} − Vₜₕ)² = (k/2)[(1 − α)(V_{Data} − V_{DD})]². Since Vₜₕ = V_{TG_S} = 0, I = (k/2)[(1 − α)(V_{Data} − V_{ER})]². Here, k = W·Cox·μ_{eff}/L, where W represents the channel width of the double gate field-effect transistor (DTFT) device, L represents the channel length of the DTFT device, Cox represents the unit area capacitance of the gate dielectric layer, and μ_{eff} represents the mobility of the semiconductor material in the channel region.

During the initialization phase (first period t1) and the compensation phase (second period t2), the adjustment signal written from the data line S to the first node N1 can be set according to specific needs. If the written voltage is Vₓ, then under the control of the preset voltage V_{MG}, the threshold voltage of the driving switch transistor is Vₜₕ =Vₓ − V_{DD}. That is, by adjusting the voltage Vₓ written to the first node N1 during the initialization phase and the compensation phase, and controlling the charging process of the third node N3 during the compensation phase, the IDVG curve (FIG. 5) of the driving switch transistor DT can be shifted to implement the setting of the threshold voltage. If Vₓ = V_{DD}, then Vₜₕ = 0. In other embodiments, Vₓ can also be set to other values, thereby setting the threshold voltage Vₜₕ to other values.

In this embodiment, by setting the second switch transistor T2 to perform initialization adjustment on the third node N3 during the initialization phase, or to reset the third node N3, the third node N3 can be accurately reset to the initial potential, avoiding the influence of the power supply voltage end VDD, effectively ensuring the compensation adjustment effect of the threshold voltage of the driving switch transistor during the compensation phase.

In this embodiment, the driving switch transistor DT and the first switch transistor T1 to the fifth switch transistor T5 are P-type transistors, which are turned on under the control of a low-level signal. Of course, the first switch transistor T1 to the fifth switch transistor T5 can also be set as other types of transistors according to specific needs, and the disclosure does not limit this. By setting the driving switch transistor DT and the first switch transistor T1 as P-type transistors, the charging speed of the third node N3 by the power supply voltage end VDD through the driving switch transistor DT and the first switch transistor T1 during the compensation phase can be effectively increased, thereby improving the response speed of the driving switch transistor DT, reducing the duration occupied by the compensation phase, and optimizing the overall compensation effect. Moreover, by electrically connecting one end of the first capacitor C1 and the second capacitor C2 to the power supply voltage VDD, since the power supply voltage VDD is a constant voltage, the coupling effect of the first capacitor C1 on the first node N1 and the coupling effect of the second capacitor C2 on the third node N3 can be effectively eliminated, thereby effectively maintaining the stability of the voltages of the first node N1 and the third node N3.

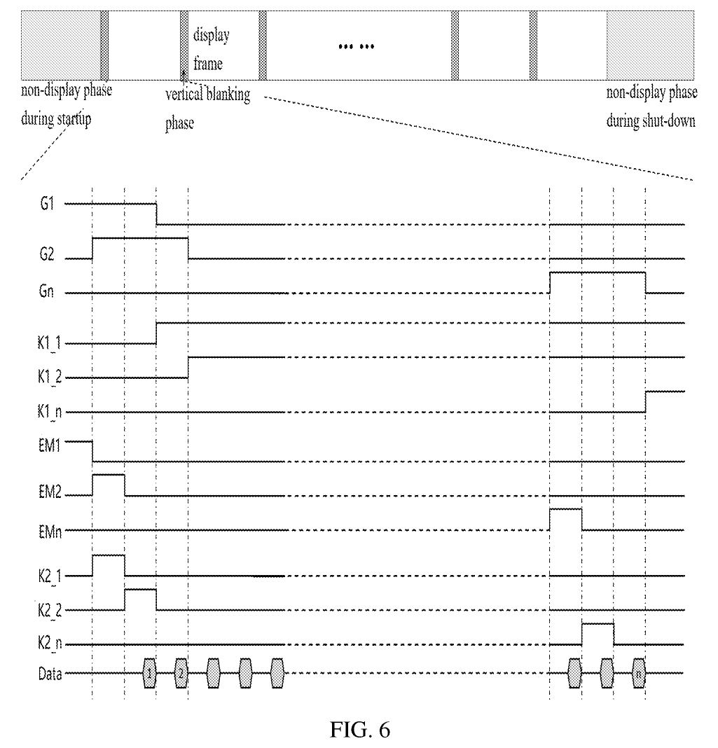

Please refer to FIG. 6, which is a signal output timing diagram of the first compensation mode of the pixel unit in FIG. 3.

As illustrated in FIG. 6, when the display panel 10 operates in the first compensation mode, during each frame of image display, the n scan lines are configured to output scan signals in sequence, and the first adjustment end K1, the second adjustment end K2, and the light-emitting control end EM are configured to output signals in a preset timing sequence to adjust the threshold voltage Vₜₕ of the first switch transistor T1 in the pixel unit 15, that is, to compensate for the threshold voltage Vₜₕ, and then receive the data signal for image display. That is, the pixel unit 15 sequentially executes the processes of the first period t1 to the fourth period t4 in each frame of image display. The first compensation mode can be performed row by row, that is, the first period t1 to the fourth period t4 are executed for all row sub-pixels in sequence.

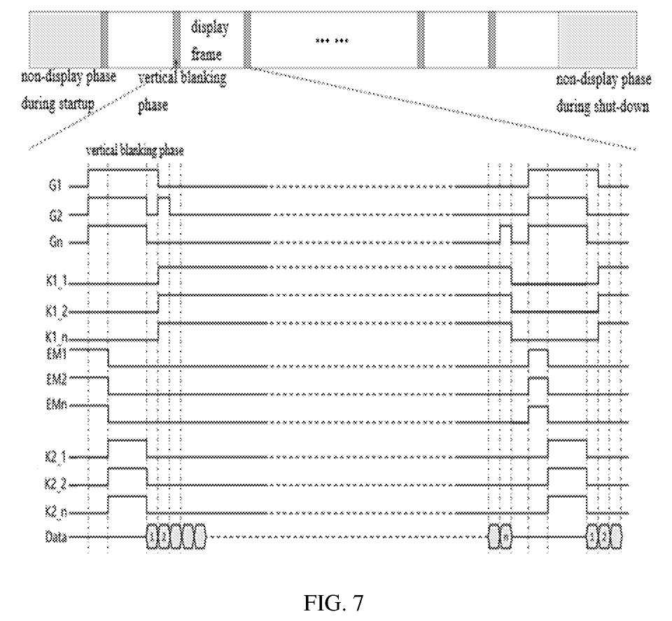

Please refer to FIG. 7, which is a signal output timing diagram of the second compensation mode.

As illustrated in FIG. 7, in the second compensation mode, during the non-image display phase, the pixel unit 15 is configured to execute the first period t1 and the second period t2 to adjust the threshold voltage of the driving switch transistor DT. During each frame of image display (display frame), the pixel unit 15 is configured to execute the third period t3 and the fourth period t4 to receive the data signal for image display. The non-image display phase can be the non-display phase during startup of the display panel 10 and the vertical blanking phase between adjacent frames of image display.

When executing the first period t1 and the second period t2 during the non-display phase, all pixel units 15 of the display panel can be compensated simultaneously, that is, full-panel compensation can be performed. Alternatively, the first period t1 and the second period t2 can be executed in each frame’s vertical blanking phase for full-panel compensation, or the first period t1 and the second period t2 can be executed once in every a frames’ vertical blanking phase for full-panel compensation, where a is an integer greater than 1. That is, the first period t1 and the second period t2 can be executed during the non-image display phase to complete the setting process of the threshold voltage of the driving switch transistor DT. Thus, during the display phase, the above two periods do not need to be executed, and instead, the third period t3 and the fourth period t4 are executed to complete the data writing and light-emitting processes.

The disclosure also has the effect of increasing the compensation range of the threshold voltage. The specific principle is as follows: from the aforementioned current formula, I = (k/2)(V_{TG_S} − Vₜₕ)². After the compensation phase and the data writing phase in the disclosure, V_{TG_S} = V_{Data} − V_{ER}, that is, V_{TG_S} does not include Vₜₕ. For the traditional single-gate driving switch transistor scheme, after the compensation phase and the data writing phase, V_{TG_S} = V_{Data} + Vₜₕ −Vᵢₙₜ, where Vᵢₙₜ can be understood as a reference voltage similar to V_{ER}. Here, V_{TG_S} (the voltage difference between the gate and source) includes Vₜₕ. Since Vₜₕ is present, it limits the write-in range of the data signal Data, so the compensation range of Vₜₕ is limited to avoid affecting the range of Data. In the disclosure, V_{TG_S} does not include Vₜₕ, so even if the range of Vₜₕ is set to be large, it will not occupy the write-in range of V_{Data}. Moreover, since the disclosure can compensate the pixel units 15 during the non-image display phase, it reduces the occupation of the image display phase. Additionally, the threshold voltage of the driving module 151 can be adjusted and compensated every multiple frames of image display, instead of compensating every frame. This avoids the problem of compressing the compensation time to ensure the refresh rate, thereby increasing the compensation time and making the compensation of the threshold voltage of the driving switch transistor more sufficient.

It should be understood that the application of the disclosure is not limited to the above examples. For those of ordinary skill in the art, improvements or transformations can be made based on the above description, and all these improvements and transformations should fall within the protection scope of the claims attached to this invention.

What is claimed is:

1. A display panel, comprising a plurality of data lines, a plurality of scan lines, and a plurality of pixel units arranged in an array, wherein the pixel units are configured to receive scan signals from the scan lines and receive data signals from the data lines under control of the scan signals, and to perform image display based on the data signals, wherein
each pixel unit of the plurality of pixel units comprises a driving module, an adjustment module, a light-emitting module, an initialization module, and a preset node, wherein the driving module is electrically connected to the adjustment module, the light-emitting module, the initialization module, and the preset node, and the preset node is also electrically connected to the adjustment module and the initialization module; the initialization module is configured to initialize the preset node to control the preset node to be at an initial potential; the adjustment module is configured to receive a power supply voltage to charge the preset node to a preset potential, to adjust a threshold voltage of a driving switch transistor in the driving module to a preset value, the driving module is configured to drive, based on the data signals, the light-emitting module to emit light.

2. The display panel of claim 1, wherein the pixel unit further comprises a first node, a second node, and a third node, the third node is the preset node, and the driving module comprises a driving switch transistor, wherein a first control end of the driving switch transistor is electrically connected to the first node, a second control end of the driving switch transistor is electrically connected to the third node, a first conductive end of the driving switch transistor is electrically connected to a power supply voltage end, and a second conductive end of the driving switch transistor is electrically connected to the second node, when the third node is at the initial potential, the driving switch transistor is turned on, and the power supply voltage end is configured to charge the third node to the preset potential through the driving switch transistor and the adjustment module, thereby controlling the driving switch transistor to be turned off and adjusting the threshold voltage of the driving switch transistor to the preset value.

3. The display panel of claim 2, wherein the pixel unit further comprises a first signal receiving module and a second signal receiving module, the first signal receiving module is electrically connected to the first node and the data line, and the second signal receiving module is electrically connected to a reference voltage end and the second node, the first signal receiving module is configured to receive an adjustment signal or the data signal from the data line and transmit the adjustment signal or the data signal to the first node, the adjustment module is configured to adjust the threshold voltage of the driving switch transistor based on the adjustment signal, the driving module is configured to drive, under control of the data signal, the light-emitting module to emit light ;
wherein the second signal receiving module is configured to receive a reference signal from the reference voltage end to control the second node to be at the initial potential.

4. The display panel of claim 3, wherein the pixel unit further comprises a first storage module and a second storage module, the first storage module is electrically connected between the first node and the power supply voltage end, and the second storage module is electrically connected between the third node and the power supply voltage end, the first storage module is configured to store and maintain the voltage of the first node, and the second storage module is configured to store and maintain the voltage of the third node.

5. The display panel of claim 4, wherein the pixel unit further comprises a light-emitting control module and a fourth node, the light-emitting control module is electrically connected to the second node and the fourth node and is electrically connected to the light-emitting module through the fourth node, wherein the light-emitting control module is configured to control the second node to be electrically connected to the fourth node.

6. The display panel of claim 5, wherein the adjustment module comprises a first switch transistor, and the initialization module comprises a second switch transistor, a control end of the first switch transistor is electrically connected to a first adjustment end, a first conductive end of the first switch transistor is electrically connected to the second node, and a second conductive end of the first switch transistor is electrically connected to the third node, the first switch transistor is configured to be turned on under control of the first adjustment end to control the second node to be electrically connected to the third node;
wherein a control end of the second switch transistor is electrically connected to a second adjustment end, a first conductive end of the second switch transistor is electrically connected to a reference voltage end, and a second conductive end of the second switch transistor is electrically connected to the third node; the second switch transistor is configured to be turned on under control of the second adjustment end to receive the reference signal from the reference voltage end and transmit the reference signal to the third node, to control the third node to be at the initial potential.

7. The display panel of claim 6, wherein the first signal receiving module comprises a third switch transistor, and the second signal receiving module comprises a fourth switch transistor, a control end of the third switch transistor is electrically connected to the scan line, a first conductive end of the third switch transistor is electrically connected to the data line, and a second conductive end of the third switch transistor is electrically connected to the first node; a control end of the fourth switch transistor is electrically connected to the second adjustment end, a first conductive end of the fourth switch transistor is electrically connected to the reference voltage end, and a second conductive end of the fourth switch transistor is electrically connected to the second node;
wherein the third switch transistor is configured to be turned on under control of the scan signal to receive the data signal or the adjustment signal from the data line and transmit the data signal or the adjustment signal to the first node, the fourth switch transistor is configured to be turned on under control of the second adjustment end to receive the reference signal from the reference voltage end and transmit the reference signal to the second node, to control the second node to be at the initial potential.

8. The display panel of claim 7, wherein the first storage module comprises a first capacitor, the second storage module comprises a second capacitor, and the light-emitting control module comprises a fifth switch transistor, the first capacitor is electrically connected between the first node and the power supply voltage end, and the second capacitor is electrically connected between the third node and the power supply voltage end, the first capacitor is configured to maintain a voltage difference between the first node and the power supply voltage end, and the second capacitor is configured to maintain a voltage difference between the third node and the power supply voltage end;
wherein a control end of the fifth switch transistor is electrically connected to a light-emitting control end, a first conductive end of the fifth switch transistor is electrically connected to the second node, and a second conductive end of the fifth switch transistor is electrically connected to the fourth node, the fifth switch transistor is configured to be turned on under control of the light-emitting control end to control the second node to be electrically connected to the fourth node.

9. The display panel of claim 8, wherein:
in a first period, the second switch transistor, the third switch transistor, the fourth switch transistor, and the fifth switch transistor are turned on, and the first switch transistor is turned off, the data line is configured to transmit the adjustment signal to the first node through the third switch transistor, and the reference voltage end is configured to transmit the reference signal to the second node and the third node through the fourth switch transistor and the second switch transistor, and further transmit the reference signal to the fourth node through the fifth switch transistor, to initialize the second node, the third node, and the fourth node;
in a second period, the second switch transistor, the fourth switch transistor, and the fifth switch transistor are turned off, and the driving switch transistor and the first switch transistor are turned on, the power supply voltage end is configured to charge the third node through the driving switch transistor and the first switch transistor; when the third node reaches the preset potential, the driving switch transistor is turned off to adjust a threshold voltage of the driving switch transistor to the preset value, the second capacitor is configured to maintain the voltage of the third node;
in a third period, the third switch transistor is turned on, and the first switch transistor, the second switch transistor, the fourth switch transistor, and the fifth switch transistor are turned off, the data signal is transmitted to the first node through the third switch transistor, and the first capacitor is configured to maintain the voltage of the first node; and
in a fourth period which is a light-emitting phase, the first switch transistor, the second switch transistor, the third switch transistor, and the fourth switch transistor are turned off, and the driving switch transistor and the fifth switch transistor are turned on, the power supply voltage end is configured to drive, through the driving switch transistor and the fifth switch transistor, the light-emitting module to emit light.

10. The display panel of claim 9, wherein the first period and the second period are executed in a non-image display phase, and the third period and the fourth period are executed in an image display phase, wherein the non-image display phase is a non-display phase during startup.

11. The display panel of claim 9, wherein the first period and the second period are executed in a non-image display phase, and the third period and the fourth period are executed in an image display phase, wherein the non-image display phase is a vertical blanking phase, and the vertical blanking phase is between two adjacent frames of image display phase.

12. The display panel of claim 11, wherein the display panel is configured to execute the first period and the second period in the vertical blanking phase of each frame.

13. The display panel of claim 11, wherein the display panel is configured to execute the first period and the second period once in the vertical blanking phase of every a frames, where a is an integer greater than 1.

14. The display panel of claim 9, wherein in each frame of the image display phase, the pixel unit is configured to sequentially execute the first period, the second period, the third period, and the fourth period.

15. The display panel of claim 9, wherein the first period is an initialization phase, the second period is a compensation phase, the third period is a data writing phase, and the fourth period is a light-emitting phase.

16. A display device, comprising a power supply module and a display panel connected to the power supply module, wherein the power supply module is configured to provide a driving power supply for the display panel to drive the display panel to perform image display, wherein the display panel comprises a plurality of data lines, a plurality of scan lines, and a plurality of pixel units arranged in an array, wherein the pixel units are configured to receive scan signals from the scan lines and receive data signals from the data lines under control of the scan signals, and to perform image display based on the data signals, wherein
each pixel unit of the plurality of pixel units comprises a driving module, an adjustment module, a light-emitting module, an initialization module, and a preset node, wherein the driving module is electrically connected to the adjustment module, the light-emitting module, the initialization module, and the preset node, and the preset node is also electrically connected to the adjustment module and the initialization module; the initialization module is configured to initialize the preset node to control the preset node to be at an initial potential; the adjustment module is configured to receive a power supply voltage to charge the preset node to a preset potential, to adjust a threshold voltage of a driving switch transistor in the driving module to a preset value, the driving module is configured to drive, based on the data signals, the light-emitting module to emit light.

17. The display device of claim 16, wherein the pixel unit further comprises a first node, a second node, and a third node, the third node is the preset node, and the driving module comprises a driving switch transistor, wherein a first control end of the driving switch transistor is electrically connected to the first node, a second control end of the driving switch transistor is electrically connected to the third node, a first conductive end of the driving switch transistor is electrically connected to a power supply voltage end, and a second conductive end of the driving switch transistor is electrically connected to the second node, when the third node is at the initial potential, the driving switch transistor is turned on, and the power supply voltage end is configured to charge the third node to the preset potential through the driving switch transistor and the adjustment module, thereby controlling the driving switch transistor to be turned off and adjusting the threshold voltage of the driving switch transistor to the preset value.

18. The display device of claim 17, wherein the pixel unit further comprises a first signal receiving module and a second signal receiving module, the first signal receiving module is electrically connected to the first node and the data line, and the second signal receiving module is electrically connected to a reference voltage end and the second node, the first signal receiving module is configured to receive an adjustment signal or the data signal from the data line and transmit the adjustment signal or the data signal to the first node, the adjustment module is configured to adjust the threshold voltage of the driving switch transistor based on the adjustment signal, the driving module is configured to drive, under control of the data signal, the light-emitting module to emit light;
wherein the second signal receiving module is configured to receive a reference signal from the reference voltage end to control the second node to be at the initial potential.

19. The display device of claim 18, wherein the pixel unit further comprises a first storage module and a second storage module, the first storage module is electrically connected between the first node and the power supply voltage end, and the second storage module is electrically connected between the third node and the power supply voltage end, the first storage module is configured to store and maintain the voltage of the first node, and the second storage module is configured to store and maintain the voltage of the third node.

20. The display device of claim 19, wherein the pixel unit further comprises a light-emitting control module and a fourth node, the light-emitting control module is electrically connected to the second node and the fourth node and is electrically connected to the light-emitting module through the fourth node, wherein the light-emitting control module is configured to control the second node to be electrically connected to the fourth node.
